(19) United States
(12) Patent Application Publication
(10) Pub. No.: US 2025/0271351 A1
(43) Pub. Date: Aug. 28, 2025

(54) Miniaturized elliptical dichroism spectrometer for stereochemical analysis

(71) Applicant: University of Denver, Denver, CO (US)

(72) Inventor: Dali Sun, Denver, CO (US)

(73) Assignee: University of Denver, Denver, CO (US)

(21) Appl. No.: 19/057,014

(22) Filed: Feb. 19, 2025

Related U.S. Application Data
(60) Provisional application No. 63/558,511, filed on Feb. 27, 2024.

(51) Int. Cl. G01N 21/19; G01N 21/21

(52) U.S. Cl. CPC G01N 21/19; G01N 21/211; G01N 2021/213; G01N 2021/216

(57) ABSTRACT

A miniaturized elliptical dichroism (mED) system for analyzing a sample includes a sample port for accepting a sample holder, an ultraviolet (UV) light source for providing UV light, optical components, a detector for detecting the incident light transmitted through the sample to generate detection data, a control board for controlling the optical components, and an enclosure for containing the UV light source, optical components, and the control board. The optical components are configured for modifying the UV light into incident light exhibiting rotating elliptical polarization and providing the UV light at the sample as incident light. A path traveled by the UV light from the UV light source to the detector defines an optical path, and the enclosure is configured for positioning the sample holder in the sample port in the optical path with respect to the UV light source, optical components, and the detector.

### REFERENCE TO RELATED APPLICATIONS

The present application claims the benefit of U.S. Pat. App. No. 63/558,511, filed 2024 Feb. 27 and titled “Minimized elliptical dichroism spectrometer for stereochemical analysis,” which referenced application is incorporated hereby in its entirety by reference.

### SPONSORED RESEARCH AND DEVELOPMENT

This invention was made with government support under contracts R03CA252783 and R21CA270748 from the National Cancer Institute and contract U54GM128729 from the National Institute of General Medical Sciences of National Institutes of Health and contract 2236885 from National Science Foundation. The government has certain rights in the invention.

### FIELD OF THE INVENTION

The present invention relates to analysis of biomolecules. In particular, but not by way of limitation, the present invention relates to systems and methods for the evaluation of stereochemical properties of biomolecules.

### DESCRIPTION OF RELATED ART

Stereochemical properties play a prominent role in determining the function of biomolecules and have been widely used to evaluate protein interactions and mechanisms of biorecognition. Various direct and indirect approaches, such as single-crystal X-ray diffraction (XRD), circular dichroism (CD), Fourier-transform infrared (FTIR), and nuclear magnetic resonance (NMR) are used to explore the allosteric configuration of a compound. However, the size, cost, and delicate nature of these systems limit their utility for biomedical study.

Particularly, when applied to stereochemical analysis, these conventional methods are time-consuming and costly, requiring elaborate instrumentation and sophisticated technicians, and large sample volumes, which limits their clinical utility, particularly in low- and middle-income countries. Further, such absorption-based spectrometers often fall short in providing structural insights, primarily focusing on quantification instead.

The study of stereochemical properties is crucial for understanding protein-folding diseases such as Alzheimer's (Polychronidou, et al., “Alzheimer's Disease: The Role of Mutations in Protein Folding,” Adv Exp Med Biol, 1195, 227-236 (2020)). For example, previous research has using stereochemical studies have revealed that proteins in cancer cells and their extracellular vesicles are rich in B-sheet structures (Rasuleva, et al., “B-Sheet Richness of the Circulating Tumor-Derived Extracellular Vesicles for Noninvasive Pancreatic Cancer Screening,” ACS Sens, 6, 4489-4498 (2021)).

Thus, there is a need for an improved methods to observe the stereochemical properties of cellular biomolecules, particularly for widely accessible and easy to use ways to perform stereochemical analyses in a variety of biological and clinical research settings.

### SUMMARY OF THE INVENTION

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In an embodiment, a miniaturized elliptical dichroism (mED) system for analyzing a sample includes a sample port for accepting a sample holder containing the sample. The system further includes an ultraviolet (UV) source for providing UV light, optical components configured for modifying the UV light to exhibit rotating elliptical polarization and providing the UV light so modified at the sample as incident light. The system further includes a detector for detecting at least a portion of the incident light transmitted through the sample and generating detection data. A path traveled by the UV light from the UV source to the detector defines an optical path. The system further includes an enclosure for containing the UV source, optical components, and detector therein, the enclosure being further configured for positioning the sample holder placed in the sample port at a predetermined orientation with respect to the UV source, optical components, and the detector in the optical path.

In embodiments, the optical path is oriented perpendicularly with respect to a surface on which the enclosure is disposed. In certain embodiments, at least a portion of the optical components are enclosed in an optical assembly configured for positioning each one of the optical components in a predetermined orientation with respect to each other one of the optical components.

The system further includes a processor for analyzing the detection data to produce analysis results. In embodiments, the processor is configured for performing one of at least two analysis routines on the detection data in producing the analysis results.

In embodiments, the mED system further includes a communication block for communicating the analysis results to an outside device located remotely from the mED system. In certain embodiments, the communication block includes at least one of a wireless communication device, a cellular communication device, an output port, and a modem.

In embodiments, the mED system further includes a ventilation system for removing unwanted gas and/or heat from the enclosure.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

FIG. 1 illustrates the basic components of an elliptical dichroism (ED) spectrometer.

FIG. 2 illustrates an exemplary mED device design and features, in accordance with embodiments.

FIG. 3 illustrates a typical ED spectrometry workflow with autocorrelation analysis.

FIG. 4 shows a comparison of the existing CD spectrometer features with the mED device, in accordance with embodiments.

FIG. 5 illustrates an alternative, exemplary mED device, in accordance with embodiments.

For simplicity and clarity of illustration, the drawing figures illustrate the general manner of construction, and descriptions and details of well-known features and techniques may be omitted to avoid unnecessarily obscuring the embodiments detailed herein. Additionally, elements in the drawing figures are not necessarily drawn to scale. For example, the dimensions of some of the elements in the figures may be exaggerated relative to other elements to help improve understanding of the described embodiments. The same reference numerals in different figures denote the same elements.

The word “exemplary” is used herein to mean “serving as an example, instance, or illustration.” Any embodiment described herein as “exemplary” is not necessarily to be construed as preferred or advantageous over other embodiments. In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or apparatuses. The following detailed description is therefore not to be taken in a limiting sense, and the scope of the present disclosure is defined by the appended claims and their equivalents.

### DETAILED DESCRIPTION OF THE INVENTION

To simplify the complex analytical methods like CD and FTIR spectroscopy used for structure analysis, an innovative elliptical dichroism (ED) spectrometer has been developed (as detailed, for example, in Bauer, et al., “A portable elliptical dichroism spectrometer targeting secondary structural features of tumorous protein for pancreatic cancer detection,” Biosens Bioelectron 222, (2023), which is incorporated herein by reference in its entirety). While this ED spectrometer leverages the absorbance of elliptically polarized light for a more straightforward approach to studying protein structures and chiroptical molecules, it is still a relatively large and complex device requiring a specially trained operator. That is, the conventional ED spectrometer enables new modes of scientific discovery and analysis, albeit with drawbacks related to portability and accessibility.

The present disclosure describes a miniaturized ED (mED) device as a widely accessible, easy-to-use tool for stereochemical analysis in every biological and clinical research setting. The device described herein provides an alternative to the conventional ED spectrometer with a size similar to commercially available, portable spectrophotometers, albeit with heretofore unavailable, additional functionalities.

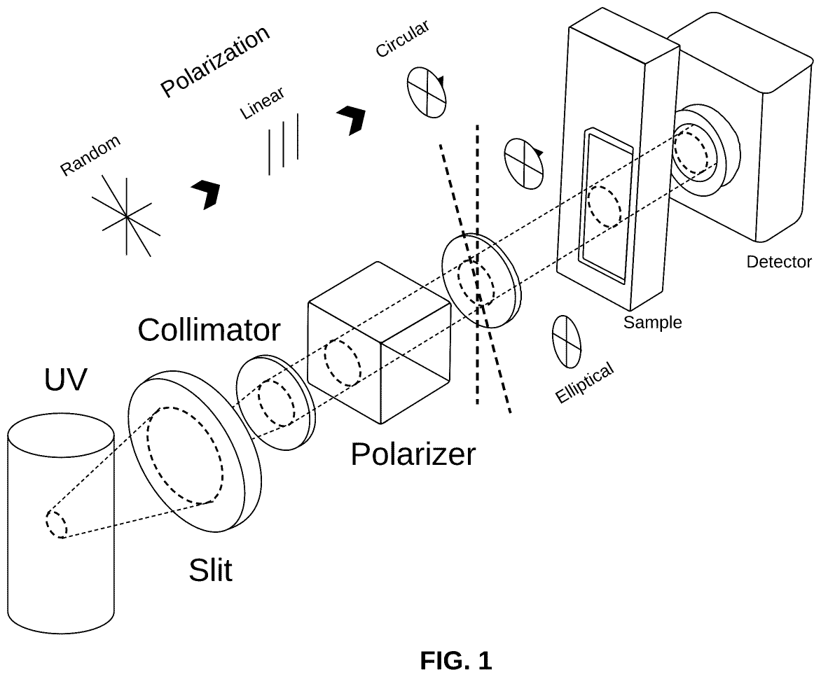

FIG. 1 illustrates the basic components of a standard ED spectrometer. Generally available as a benchtop device, such as on an optical bench, light from a UV light source (e.g., a deuterium lamp) is directed through a series of optical components, such as a slit and/or aperture, a collimator, a polarizer, and a waveplate. The resulting conditioned light is provided as elliptically polarized light at a sample.

The light signal transmitted through the sample is then captured at the detector, which is configured for sensitivity in the UV wavelength range, as the waveplate is rotated to modify the polarization state of the light incident on the sample. The captured data from the detector is then be processed for stereochemical analysis. Such conventional, benchtop ED spectrometer systems are described in previous publications [3].

In contrast, the present disclosure describes a micro liquid, easy-to-use, miniaturized elliptical dichroism (mED) device for stereochemical analysis, validated for characterizing the structures of small and macro biomolecules. The mED device described herein adopts the absorbance of left and right-oriented elliptical polarization to target protein structure features by allosteric absorption, while providing a significantly more compact system profile, additional analytical capability that not only differentiates structural variations but also quantifies the target molecule, and reduced sample size requirements.

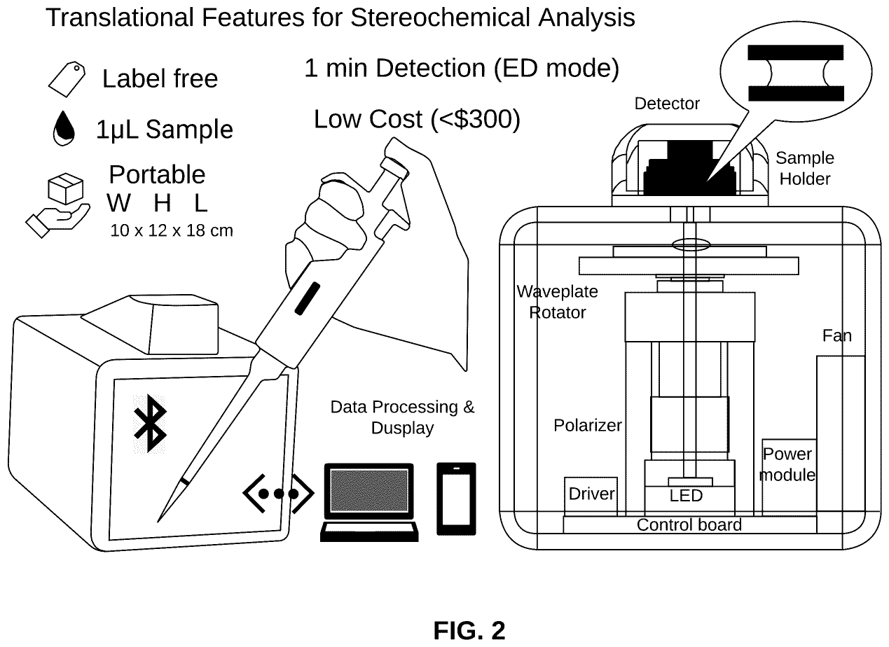

FIG. 2 shows a representative illustration of an exemplary mED device. As shown on the right-hand side of FIG. 2, the exemplary mED device includes an enclosure containing a control board, onto which a driver/processor and a power module are mounted. The control board provides a stable base onto which an optical assembly (shown as a white tube) may be placed. The optical assembly includes one or more UV LEDs (shown as a single LED block in FIG. 2) providing UV light in an upward direction in the figure. The UV LED package may be integrated into the control board to provide the correct alignment between the UV source and the subsequent optical components. In this way, a smaller, cheaper UV light source (such as a UV-C surface-mounted device SMD3535 265 nm LED at 2 to 3 mW with an average lifespan of 8000 hours with a price point of approximately $30 each) may replace the deuterium lamp (costing hundreds of dollars each) used in the conventional ED system.

Additional optical components, such as a linear polarizer, one or more refractive optical components and/or one or more waveplates, are supported by the optical assembly such that the optical components are positioned with respect to the UV LED and a detector. In this way, the LEDs and optical components may be structurally fixed with respect to each other.

The detector may be, for example, a UV-enhanced silicon detector (e.g., 918D-UV-OD3R UV enhanced silicon (UV-Si) photo detector available from Newport Corporation) equipped with an attenuator for recording absorption, rather than a gallium-phosphide detector used in conventional ED spectrometers. In embodiments, the mED may be configured to minimize any direct or specularly reflected light from reaching the detector lens and the detector itself (e.g., by using a UV-enhanced silicon detector with an attenuator (such as 918D-UV-OD3R, 200-1100 nm, available from Newport).

In embodiments, the waveplate is rotatable to provide UV input light of rotating elliptical polarization states toward the detector. The path of travel of the UV light from the UV LED to the detector defines an optical path.

The optical system layout in the mED may be designed with a vertical stack design, as shown in FIG. 2, compared to the horizontal design of conventional ED spectrometers. Such a vertical design enables a more compact and stable stacking of the optical components, thus leading to increased portability and the use of smaller components while achieving similar performance compared to the existing ED spectrometers. In other words, the optical path of the mED is oriented vertically with respect to a table or benchtop surface, in certain embodiments.

As shown in FIG. 2, in certain embodiments, a sample port disposed between the optical assembly and the detector enables the positioning of a sample holder in the optical path at a predetermined position between the optical assembly and the detector. The sample port may be configured to accept therein a standardized sample holder such that the sample is insertable into the optical path in a repeatable, consistent manner. In certain examples, the sample holder may be, for example, a flat metal piece including a small aperture opening for containing a small amount of sample (e.g., on the order of a microliter) therein by capillary forces. As an example, the sample holder may be a stainless-steel disc with a 2-millimeter thickness and a 1-millimeter opening formed therein. This configuration is advantageous because the hydrophilic nature of stainless steel allows it to hold sample volumes through capillary action. Its anti-corrosion properties also make it suitable for various sample liquids. Further, the metal sample holder itself may serve as a light-blocking aperture to reduce any stray UV radiation from entering the detector. Such a sample holder significantly reduces the required sample amount from the approximately 200-microliter sample size required in conventional ED spectrometers, while also providing optical functionalities to reduce stray light entering the detector.

Additionally, the data from the detector may be processed to produce analysis results according to one of several selectable analysis modes. In embodiments, the system further includes a processor configured to control the electromechanical components, such as rotating the rotor for the waveplate, while simultaneously acquiring data from the detector. The processor may be further configured to process the acquired data through a predefined routine, including noise reduction, and output the processed data to an external display via a communication port, such as a USB port.

For example, using the same optical components, the mED may be operated in various modes such as: 1) an angle sweeping (AS) mode presenting molecular stereochemical signature, in which a circular pattern may be used to identify the molecules within a given sample (see, for example, Balamurugan, et al., “Automating the amino acid identification in elliptical dichroism spectrometer with Machine Learning,” PLOS One, 2025); 2) elliptical dichroism (ED) mode as a CD alternative, in which the ED value may be used to characterize the structural differences between different samples (see, for example, Bauer, et al., “A portable elliptical dichroism spectrometer targeting secondary structural features of tumorous protein for pancreatic cancer detection,” Biosensors and Bioelectronics, vol. 2222, 114934, 2023); 3) Autocorrelation (AC) mode presenting symmetricity, by which the quantity of a particular molecule within a sample may be characterized (see, for example, Asad, et al., “Characterizing biomolecular structure features through an innovative elliptical dichroism spectrometry for cancer detection,” Heliyon, vol. 10, issue 19, e38399, 2024); and (4) AC at 180° as UV absorption indicator. These modes, all enabled by the mED, offer tools for biomolecular stereochemistry and detecting allosteric changes due to interactions. For example, in AC mode, the mED may be configured to provide autocorrelation analysis of the signal obtained at the detector as the waveplate is rotated. In this way, the mED may be operated essentially as an absorption spectrometer, not simply as a less expensive circular dichroism spectrometer. The autocorrelation mode operation also provides reduced noise and bias in the resulting analysis results.

Beyond a simple compactization of the conventional ED spectrometer, the mED device described herein includes a variety of heretofore unseen advantages such as, and not limited to:
1) Ruggedized, portable system due to the orientation of the optical path in a perpendicular direction with respect to the surface on which the mED system is placed, thus providing stability in the optical path from the UV source through the optical components and the sample and into the detector;
2) The integration of the electronic components (e.g., control board, LED package(s), driver, and power module) at the base of the support structure within the system enclosure;
3) A sample port integrated into the system enclosure to enable repeatable, consistent insertion of the sample into the optical path of the mED;
4) Innovative sample holder design, enabling the use of very small sample sizes while having the sample holder itself have a dual function as a sample holder and stray light blocking aperture; and
5) Multi-mode operation, with different analysis modes selectable by software.

The mED described herein may be considered a platform technology, capable of supporting a variety of activities in biomedical study and clinical development as a convenient tool for stereochemical molecular and cellular analysis. The mED provides a portable, low-cost alternative to the delicate instrumentation currently used for structural analysis of biomolecules (e.g., CD, NMR, XRD, FTIR, Raman). Additionally, the mED may provide superior translational features (i.e., low sample consumption, easy operation, and multiple working modes and functions), thus significantly expanding the scope of cellular analysis and providing deeper insight into cell homeostasis in a label-free way to enable new biological studies about stereochemical markers. The mED may be used, for example, to uncover stereochemical signatures, stereoselectivity, and proteostasis in cells and extracellular vesicles (EVs), thus presenting new biomarker possibilities.

Fewer or additional components than shown in FIG. 1 may be included in the optical path (shown as a gray strip connecting the UV light source through the optical components, sample, and to the detector) to condition the UV light delivered to the sample, and such modifications in the specific optical components are considered to be a part of the present disclosure.

Further improvements over the conventional ED spectrometer are contemplated such as, and not limited to, the use of a compact motorized rotator for the waveplate rotation (e.g., Stingray Class Servo Gearbox available from goBILDA), incorporation of ventilation features, such as a fan and/or vents for heat dissipation and ozone mitigation, integral formation of different optical components and/or enclosure assemblies (e.g., the optical assembly and/or system enclosure) with customized slots to accommodate specifically designed components for the mED; and other improvements considered to be a part of the present disclosure. For instance, the mED may include a single collimator with aspherical surfaces, a Glan-Taylor prism polarizer, and a quarter waveplate, for example.

In embodiments, the optical components may be fabricated with a half-inch diameter by the diamond turning method at an optics manufacturer, such as Karl Lambrecht Corporation (Chicago, IL). In certain embodiments, the mechanical parts may be formed using techniques such as additive manufacturing, machining, extrusion, and injection molding.

In embodiments, the mED includes circuitry for functionalities such as: 1) LED driving; 2) detector controlling; 3) waveplate rotator controlling; 4) fan controlling; 5) USB access; 6) Bluetooth access; 7) system control (e.g., using an Arduino UNO); and 8) power. mED system may be connected via the USB and/or Bluetooth access with an external computer, for example, to read and analyze the collected data at the sensor.

To enhance the mED device for molecular stereochemical analysis, the mED may additionally be provided with features such as temperature control, pressure control, and stopped-flow for kinetics study.

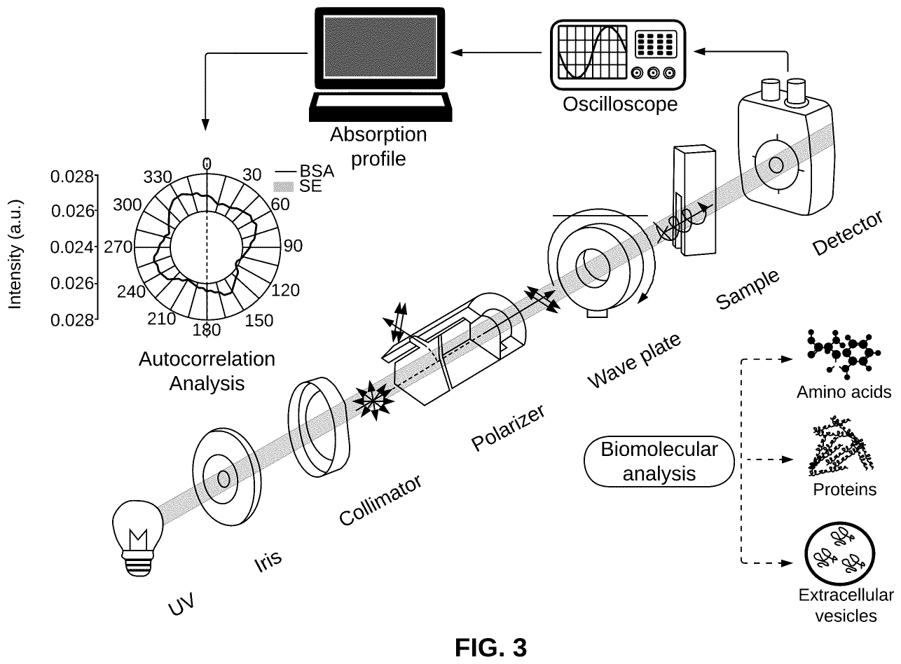

FIG. 3 illustrates a typical ED spectrometry workflow with autocorrelation analysis. Beginning with a UV light source, such as a deuterium lamp, light is linearly polarized using a combination of an iris, a collimator, and a linear polarizer. The light output is then transformed into elliptically polarized light via a rotatable waveplate. The elliptically polarized light interacts with the biomolecular sample before reaching a detector. The detector output may be processed through an oscilloscope to output an absorption profile for the biomolecular sample, viewable on an external device such as a computer as shown in FIG. 3. Autocorrelation analysis of the absorption profile enables the structural characterization of biomolecules, including amino acids, proteins, and extracellular vesicles.

It is notable that the typical ED set-up, such as shown in FIG. 3, is generally assembled on an optical bench within an experimental laboratory. Even purportedly “portable” ED systems (see Bauer, et al.) are bulky systems with components assembled on a breadboard. Such conventional systems are still heavy, the optical components are sensitive to misalignment, and not practical for use requiring moving of the system to various locations.

In contrast, the essential components involved in an ED spectrometry measurement, such as illustrated in FIG. 3, are contained in a compact format in the mED, such as shown in FIG. 2. As a result, the mED as described herein is be significantly more compact, portable, and simple to use, without the need for specially trained personnel and cooling requirements. Consequently, the mED may be applied straightforwardly to biomedical study and clinical practice without training and is also amenable to high-throughput automation in both clinical and research labs.

While advanced techniques, such as MRI, CD, FTIR, Raman, and NMR have become integral to clinical diagnosis and molecular analysis, the complexity of these technologies poses challenges to their miniaturization and broader adoption. In contrast, mED enables ready use of compact spectroscopy in a variety of settings, making it an essential tool in a variety of biological and clinical laboratory settings.

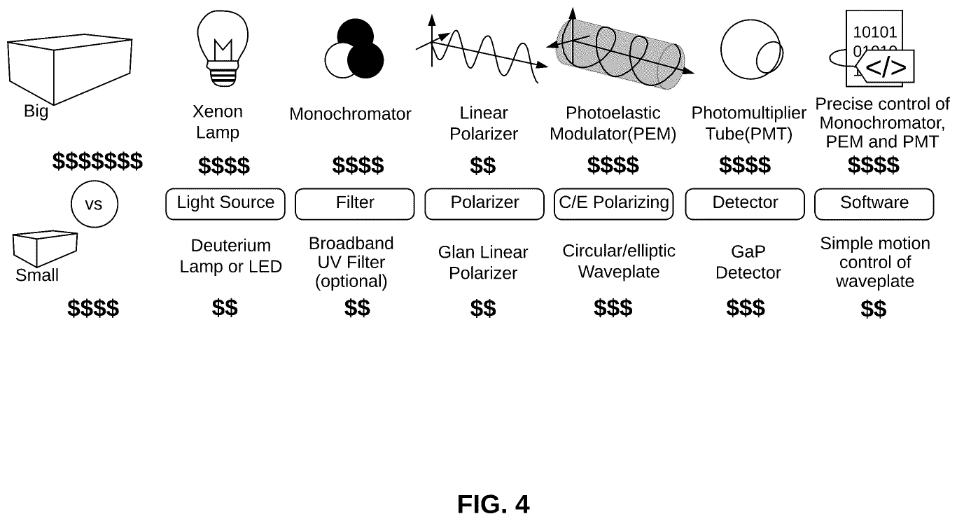

FIG. 4 shows a comparison chart highlighting key differences between conventional CD spectrometers and the mED spectrometer described herein. The characteristics of conventional CD spectrometers are shown across the top row of FIG. 4, while the characteristics of the mED system described herein are shown across the bottom row. Several of the characteristics of conventional CD spectrometers also overlap with benchtop ED spectrometers.

As shown in FIG. 4, a conventional CD spectrometer is generally a benchtop device having width×depth×height dimensions of approximately 70 cm×54 cm×32 cm for a standard CD spectrometer available from Jasco, with a list price of $85,000 or more. Conventional CD spectrometers generally use Xenon lamps as the light source, which cost $1,000 or more to replace. Other components of the conventional CD spectrometer includes a monochromator (^{˜$}2,000), linear UV polarizer (^{˜$}150), photoelastic modulator (PEM) (^{˜$}200), photomultiplier tube (PMT) (^{˜$}1,500), and control electronics for precise control of monochromator, PEM, and PMT.

In contrast, the mED is small in dimensions (10 cm×12 cm×18 cm or less), requires less expensive components (e.g., Deuterium lamp (<$500) or even UV-C light emitting diode(s) for ^{˜$}200, an optional broadband UV filter, linear polarizer (^{˜$}150), a rotatable waveplate ($^{˜$}200), a GaP UV photodetector (^{˜$}200)) and the control electronics only needs to control the rotation of the rotatable waveplate, thus only requiring a smaller rotator compared to the larger components used in the conventional CD spectrometer. Further, referring again to FIG. 2, the mED of the present disclosure includes a unique vertical alignment of the optical components to enable stability as well as the use of very small sample sizes of a few microliters (e.g., 2-10 microliters) rather than the insertion of cuvettes requiring hundreds of microliters of sample. The optical components are supported on a frame to simplify assembly and preserve alignment even during portable use and, compared to the benchtop CD and ED spectrometer systems, the shortened optical path between the light source and detector enables the use of less expensive UV optical components and a smaller detector, while maintaining comparable measurement performance as the benchtop CD and ED systems.

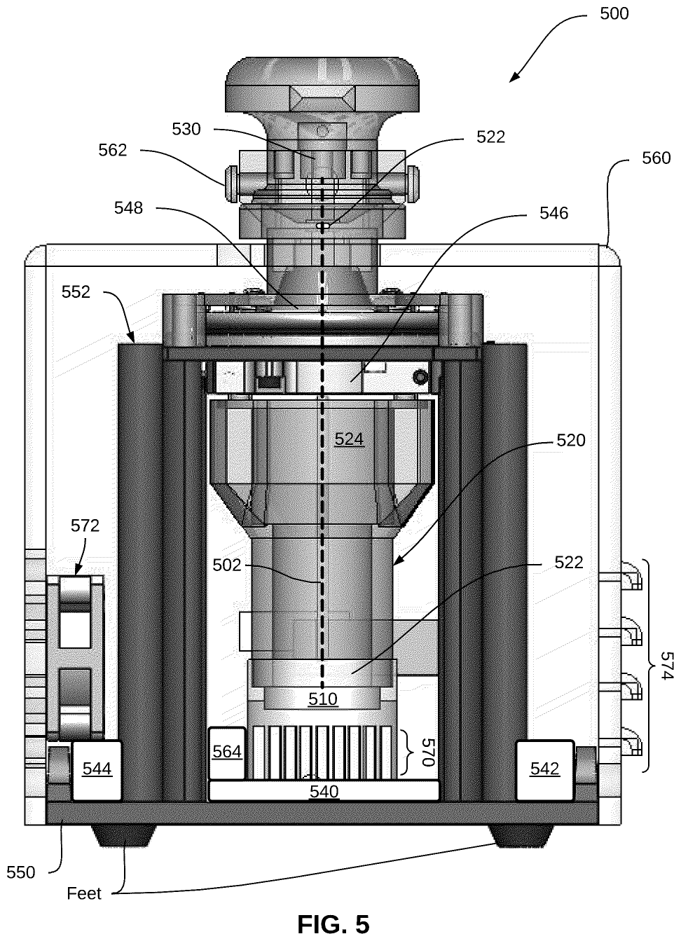

FIG. 5 illustrates further details of an alternative, exemplary mED device, in accordance with embodiments. As shown in FIG. 5, mED device 500 includes components similar to those of the version shown in FIG. 2. That is, mED device 500 features a stack of components, with a vertically defined optical path 502 from an LED light source 510, an optical assembly 520, through a sample supported within a sample holder 522 to a detector 530. In embodiments, optical assembly 520 includes a collimator 522, a polarizer 524, and a rotating stage 546 configured for supporting a waveplate 548 thereon, with the various components included within optical assembly 520 being positioned at fixed distances with respect to each other, LED light source 510, and detector 530. In embodiments, optical assembly 520, LED light source 510, as well as a control board 540, a power block 542, and a driver 544, are securely mounted on a base 550.

Additionally, a frame 552 is provided to further support the various components in alignment. A case 560 encloses the optical and power components of mED device 500 to protect the alignment of the optical components as well as protecting the user from the power components, while enabling ready access to the sample holder. In embodiments, frame 552 and/or case 560 may be formed of a non-conductive material. In certain embodiments, case 560 may be formed of a material that blocks the transmission of UV light therethrough so as to protect a user of the mED device from stray UV light. Additionally, the case may be formed of a waterproof or water-resistant material such that, with the addition of appropriate gaskets and/or sealing material at the seams, enable the mED device to be safely used in moist environments.

One or more output interface(s) 562 also enable access to the output data from the detector. Optionally, one or more wireless, BLUETOOTH® technology, or other interfaces may be integrated into mED device 500 to enable wireless extraction of detector data to an external device. For example, a communication block 564 may be integrated into the control board or the detector to serve as a communication interface.

In embodiments, mED device 500 also includes fins 570 that serve as a heatsink for dissipation of heat from the LED light source and control board as necessary. The combination of an internal fan 572 with vents 574 disposed on opposing sides of case 560 also assist with heat management of driver 544, LED light source 510, control board 540, and power block 542 included within mED device 500.

The mED device described herein revolutionizes elliptical dichroism (ED) spectroscopy by offering a highly simplified, low-cost, and user-friendly alternative to traditional circular dichroism (CD) and ED spectrophotometers. Designed for seamless operation without specialized training, it is accessible to every lab—from cutting-edge research facilities and clinical diagnostics to pharmaceutical development and even high school STEM labs. The mED accommodates extremely small sample volumes, making it versatile for various applications while maintaining or exceeding the performance of conventional systems. Its multifunctional capabilities provide simultaneous structural and quantitative analysis in a single readout, enabling efficient, real-time insights. With its compact design, affordability, and broad applicability, the mED device democratizes stereochemical analysis, ensuring that high-precision molecular characterization is no longer confined to specialized labs but available to all.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms-even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of a “protrusion” should be understood to encompass disclosure of the act of “protruding”—whether explicitly discussed or not—and, conversely, were there only disclosure of the act of “protruding”, such a disclosure should be understood to encompass disclosure of a “protrusion”. Such changes and alternative terms are to be understood to be explicitly included in the description.

1. A miniaturized elliptical dichroism (mED) system for analyzing a sample, the system comprising:
a sample port for accepting a sample holder containing the sample therein;
an ultraviolet (UV) light source for providing UV light;
optical components configured for
modifying the UV light into incident light exhibiting rotating elliptical polarization, and
providing the UV light so modified at the sample as incident light;
a detector for detecting at least a portion of the incident light transmitted through the sample to generate detection data;
a control board for controlling the optical components; and
an enclosure for containing the UV light source, optical components, and the control board therein,
wherein a path traveled by the UV light from the UV light source to the detector defines an optical path, and
wherein the enclosure is configured for positioning the sample holder in the sample port at a predetermined orientation in the optical path with respect to the UV light source, optical components, and the detector.

2. The system of claim 1,
wherein the enclosure is configured for placement on an external surface, and
wherein the optical path is oriented perpendicularly with respect to the external surface.

3. The system of claim 1, further comprising:
an optical assembly for supporting each one of the optical components therein in a predetermined orientation with respect to each other one of the optical components.

4. The system of claim 3, further comprising:
a frame for supporting the UV light source, the optical assembly, and the control board in a fixed position with respect to each other within the enclosure.

5. The system of claim 1, further comprising:
a processor for receiving detection data from the detector and analyzing the detection data to produce analysis results.

6. The system of claim 5, wherein the processor is further configured for performing two or more analysis routines on the detection data in producing the analysis results.

7. The system of claim 1, further comprising a communication block for communicating the detection data to an external device.

8. The system of claim 7, wherein the communication block includes at least one of a wireless communication device, a cellular communication device, an output port, and a modem.

9. The system of claim 1, wherein the enclosure further contains a ventilation system.

10. The system of claim 9, wherein the ventilation system includes at least one of a fan and a plurality of vents for removing at least one of unwanted gas and generated heat from the enclosure.
